(19) United States
(12) Patent Application Publication
(10) Pub. No.: US 2021/0340054 A1
(43) Pub. Date: Nov. 4, 2021

(54) OPTICAL GLASS WITH LOW DENSITY

(71) Applicant: Schott AG, Mainz (DE)

(72) Inventors: Bianca Schreder, Sulzbach (DE); Ute Wölfel, Mainz (DE); Stefanie Hansen, Gensingen (DE)

(73) Assignee: Schott AG, Mainz (DE)

(21) Appl. No.: 17/307,572

(22) Filed: May 4, 2021

(30) Foreign Application Priority Data
May 4, 2020 (DE) 10 2020 111 949.6

(51) Int. Cl. C03C 3/066

(52) U.S. Cl. CPC C03C 3/066; C03C 2201/42; C03C 2204/00; C03C 2201/54; C03C 2201/50

(57) ABSTRACT

A glass has a low ratio of density ρ and refractive index n_{d}. The glass has a refractive index n_{d} in a range of 1.80 to 2.00, an internal transmission of at least 80% (450 nm, 10 mm), a dispersion v_{d} of 19.0 to 27.0, and a ratio ρ/n_{d} of <1.97.

### CROSS REFERENCE TO RELATED APPLICATIONS

This application claims priority to German Patent Application No. DE 10 2020 111 949.6 filed on May 4, 2020, which is incorporated in its entirety herein by reference.

### BACKGROUND OF THE INVENTION

### 1. Field of the Invention

The invention relates to an optical glass, a glass article and the use thereof.

### 2. Description of the Related Art

The invention deals with glasses which can be used in the field of augmented reality (AR). For AR eyeglasses highly refractive glasses—thus glasses with a high refractive index—are advantageous, because they increase the field of view (FoV). On the other hand, the density of such glasses often increases disproportionately with increasing refractive index. This means, even when it is possible to make wafers thinner for the AR application, that the glass for eyeglasses would become considerably heavier, which makes the longer wearing of AR eyeglasses uncomfortable. Since there is a tendency from headsets to standard shapes of eyeglasses which then should be worn longer or like normal eyeglasses always, it is necessary to make the eyeglasses lighter. This weight reduction is also an advantage for many other fields of application, because camera optics in the DSLR field also very often are either extremely bulky or extremely heavy which also considerably increases the battery power requirement of the autofocus.

Some of the glasses of prior art originate from the niobium phosphate or titanium phosphate system, thus they contain P₂O₅ and niobium or titanium in considerable portions. During the production, to some extent, these glasses are very problematic, because oxygen loss, e.g., due to melting and refining temperatures which are too high in the phosphate system which already is characterized by reducing effects leads to lower oxidation states. In the case of niobium this is, e.g., an oxidation state of lower than V, and in the case of titanium of lower than IV. In the case of the niobium system, this may result in an intense brown to black coloration, or in a coloration of yellow-green to brown in the case of the titanium system. In addition, titanium considerably increases the tendency to crystallization which in the field of heavy flint is a known problem of the existing higher refractive glasses which then, e.g., can no longer be remolded by compression. In contrast to niobium, even the highest oxidation state of titanium absorbs at the edge of the visible range, which in the case of higher contents is the reason for the known yellowness of the barium-titanium silicates.

Furthermore, the niobium phosphate glass family—such as also the highly refractive heavy flint or lanthanum heavy flint family—is not only characterized by a tendency to interface crystallization, but also shows a very quick crystal growth which is critical, when glasses which optionally contain crystal seeds should subsequently be cooled (stress cooling or adjustment of refractive power). In addition, it is known that the glass is relatively brittle and therefore it can only hardly be polished into very thin wafers.

On the other hand, the climate resistance, at least in the case of the niobium phosphate glasses despite P₂O₅ is relatively good and the density for this high refractive power is very low which increases the wearing comfort. These families are known from literature.

The glasses N-LASF46B, N-SF66 and P-SF67 which are available on the market are in a refractive power range which is interesting for the AR application. N-SF66 even would have a favorable combination of refractive power and density, but as already mentioned above only hardly and only with yield losses can be processed into wafers. The lanthanum heavy flint systems are characterized by a considerably more unfavorable combination of refractive index n_{d} and density (substantially, the high density of the glasses is responsible for the higher v_{d} of the lanthanum heavy flint glasses) and a relatively high hardness which increases the costs of the wafer production by the long times of grinding. Normally, also already the costs of the raw glasses are considerably higher, because for these glasses raw materials from the rare earth field, tungsten oxide, tantalum oxide and other expensive raw materials are used. In the field of the heavy flints often Nb₂O₅ is the cost driver of the mixture, while the other raw materials in comparison thereto even in optical quality are relatively inexpensive.

On the one hand, the P-SF glasses in this range of the Abbe diagram are problematic due to their mixture costs and, in addition, they are extremely soft (can easily be scratched) due to their high portion of Bi₂O₃ and they have a comparatively poor UV edge of transmission. In addition, both glasses are discontinuously prepared in the platinum crucible, and it is possible that they lead to problems in a trough with platinum alloy and reduction of Bi(III) down to Bi(0).

Such as already mentioned above, there are some glasses which are suitable more or less, but which often still are in the range of too low refractive powers (typical heavy flint glasses) or which only hardly can be processed (typical lanthanum heavy flint glasses).

What is needed in the art are glasses which have a high refractive index n_{d} and at the same time a density which is low. The glass should have an internal transmission which is high, heat forming of the glass should easily be possible, and it should be easy to process it. For this, the hardness must not be too low (more scratches and microcracks), but also not too high (long times of grinding and thus also microcracks). Also, the thermal expansion should not be too high. The chemical resistances should also be good.

### SUMMARY OF THE INVENTION

In some exemplary embodiments provided according to the invention, a glass with a low ratio of density ρ and refractive index n_{d} is provided. The glass has a refractive index n_{d} in a range of 1.80 to 2.00, an internal transmission of at least 80% (450 nm, 10 mm), a dispersion v_{d} of 19.0 to 27.0, and a ratio ρ/n_{d} of <1.97.

In some exemplary embodiments provided according to the invention, a glass article includes a glass with a low ratio of density ρ and refractive index n_{d}. The glass has a refractive index n_{d} in a range of 1.80 to 2.00, an internal transmission of at least 80% (450 nm, 10 mm), a dispersion v_{d} of 19.0 to 27.0, and a ratio ρ/n_{d} of <1.97. The glass article is in the form of a glass for eyeglasses, a stack of wafers, a wafer, a lens, a spherical lens, a prism, an asphere, a light wave guide, a fiber, or a plate.

### BRIEF DESCRIPTION OF THE DRAWINGS

The above-mentioned and other features and advantages of this invention, and the manner of attaining them, will become more apparent and the invention will be better understood by reference to the following description of (an) embodiment(s) of the invention taken in conjunction with the accompanying drawing(s), wherein:

FIG. 1 illustrates an internal transmission spectra of an exemplary embodiment of a glass provided according to the invention;

FIG. 2 illustrates an internal transmission spectra of another exemplary embodiment of a glass provided according to the invention;

FIG. 3 illustrates an internal transmission spectra of another exemplary embodiment of a glass provided according to the invention; and

FIG. 4 illustrates an internal transmission spectra of another exemplary embodiment of a glass provided according to the invention;

Corresponding reference characters indicate corresponding parts throughout the several views. The exemplification(s) set out herein illustrate(s) (one) embodiment(s) of the invention (, in one form,) and such exemplification(s) (is)(are) not to be construed as limiting the scope of the invention in any manner.

### DETAILED DESCRIPTION OF THE INVENTION

In some exemplary embodiments provided according to the invention, a glass with a low ratio of density ρ and refractive index n_{d} is provided, wherein the refractive index n_{d} of the glass is in a range of 1.80 to 2.00 and the glass has an internal transmission of at least 80%, such as at least 85% or at least 90%, measured at a wavelength of 450 nm and a sample thickness of 10 mm. The glass has a dispersion v_{d} of 19.0 to 27.0, such as of >20.0 to 26.0 or of >20.0 to 25.5. The glass is characterized by a ratio ρ/n_{d} of <1.97, such as <1.95 or lower than 1.93 or even lower than 1.90 or lower than 1.89 or lower than 1.87, lower than 1.85, lower than 1.83, lower than 1.81 or even lower than 1.80. In some embodiments, the refractive index n_{d} is 1.83 to 1.99, such as at least 1.84, at least 1.85 or at least 1.87.

The internal transmission or the internal transmittance can be measured with the help of methods which are known by a person skilled in the art, for example according to DIN 5036-1:1978. In this description, the information given with respect to the internal transmission relates to a wavelength of 450 nm and a sample thickness of 10 mm. The information given with respect to a “sample thickness” does not mean that the glass has this thickness, because it only means that the information given with respect to the internal transmission relates to this thickness.

Unless otherwise specified or obvious for a person skilled in the art, here described measurements are conducted at 20° C. and an air pressure of 101.3 kPa.

The density of the glass may be from 3.0 g/cm³ to 3.9 g/cm³. In some embodiments, the density is at most 3.85 g/cm³, at most 3.8 g/cm³, or at most 3.7 g/cm³. In some embodiments, the density is from 3.2 to 3.6 g/cm³ or from 3.1 to 3.5 g/cm³.

Thus, the range of the refractive index of the glass is adjacent and above the known heavy flint range, but with decreased density. Normally, an increase of the refractive power together with a decrease of the density is a contrary specification, because in conventional glass development the refractive index has been increased either by heavier elements, whereby normally the density increases and the dispersion decreases, or by producing a narrower glass network, whereby the volume of the glass decreases and thus also the density increases and the refractive index and the dispersion also are increased. The inventors have succeeded in increasing the refractive index such that neither the volume nor the molar mass are changed, or in maintaining the refractive index and at the same time decreasing the molar mass and increasing the volume, respectively. When it is considered that in the theory of the development of optical glasses often the “molecular refraction” of the single components is discussed and that a lot of developments are realized via factors which reflect the refractive power portion of a component in the glass, then the difficulty of the solved problem becomes apparent.

The combined content of Nb₂O₅, TiO₂ and BaO may be at least 30.0% by weight, such as at least 45.0% by weight. Optionally, the content of these oxides is at most 75.0% by weight or at most 70.0% by weight.

Optionally, the glass has a content of Ta₂O₅, WO₃ and/or GeO₂ of less than 5.0% by weight, such as less than 1.0% by weight.

In some embodiments, the glass has a Knoop hardness of 500 to 650, such as of 520 to 600 or up to 580. The hardness should not be too low (more scratches and microcracks), but also not too high (long times of grinding and thus also microcracks).

In the production, the glass should be manufactured free of streaks in net widths of at least 200 mm or better at least 300 mm and with ingot thicknesses of at least 20 mm, better at least 40 mm or at least 50 mm. In some embodiments, the invention relates to an ingot made of the glass described here, such as with a width of at least 200 mm and/or a thickness of at least 20 mm. Optionally, the ingot has a width of at least 300 mm and/or a thickness of at least 40 mm or at least 50 mm. Therefore, a lower tendency to crystallization is important, because melts with low viscosity are very susceptible to the formation of middle streaks and margin streaks which can reach deep into the volume. For glasses in the field of the heavy flint systems this is particularly critical, since titanium and zirconium are known as nucleating agents. Therefore, in the glasses ZrO₂ should not be used, if possible, or it should only be used in low amounts. Titanium should especially be stabilized for avoiding crystal formation at interfaces. In the glass described here this stabilization has been achieved. So, the glass can be manufactured to wafers in good yield.

In some embodiments, the glass has a glass transition temperature Tg of 500° C. to 650° C., such as of 520° C. to 630° C. Optionally, Tg can be at most 650° C., at most 625° C., at most 620° C. or at most 615° C. The glasses are well suited for heat forming and processing.

The chemical resistance should be suitable for the use in AR eyeglasses. Eyeglasses are cleaned frequently and to a certain degree they have to withstand a chemical attack. The chemical resistance may correspond to a class 0, 1 or 2 according to DIN 12116:2001. A sufficient chemical resistance may also be important for the processing of the glass. In some post-processing processes a part of the sodium leaches out and forms salts with chloride from the surroundings. In the case of this glass, it is beneficial if this does not happen.

Also, the mean coefficient of thermal expansion in the temperature range of 20 to 300° C. (CTE) should not be too high, such as in the range of 8.0 to 12.0 ppm/K, such as in the range of 9.0 to 11.0 ppm/K. The CTE is determined according to DIN ISO 7991:1987.

In some embodiments, the glass provided according to the invention contains niobium and/or titanium. Niobium containing glasses are known for being characterized by a poorer internal transmission in the near-UV visible spectral range and due to the content of titanium by a strong tendency to interface crystallization. In the case of the glass provided according to the invention, these disadvantages do not arise or only arise in a manageable extent.

Optionally, the glass contains much niobium, followed by titanium and barium. Here, niobium can be replaced by titanium. The mass portions ratio Nb₂O₅/TiO₂ should be between 0.3 and 3.5. These components result in a high refractive power in the case of moderate and decreased density. In some embodiments, the content of Nb₂O₅ in the glass is at least 10.0% by weight, such as at least 11.0% by weight, at least 12.0% by weight or at least 20.0% by weight. In some embodiments, the content is even at least 20.0% by weight or at least 25.0% by weight. Optionally, the content of Nb₂O₅ can be limited to at most 55.0% by weight, at most 50.0% by weight, at most 45.0% by weight or at most 40.0% by weight or at most 35.0% by weight.

The content of TiO₂ can be at least 10.0% by weight, such as at least 11.0% by weight, or at least 12.0% by weight. In some embodiments, the content is even at least 14.0% by weight or at least 15.0% by weight or at least 17.0% by weight. Optionally, the content of TiO₂ can be limited to at most 50.0% by weight, at most 45.0% by weight, at most 42.0% by weight or at most 40.0% by weight or at most 39.0% by weight.

The glass may contain BaO. The content of BaO can be at least 0.1% by weight, at least 0.2% by weight, at least 0.5% by weight or at least 1.0% by weight, such as at least 2.0% by weight. Optionally, the content of this component is limited to at most 35.0% by weight, at most 30.0% by weight, at most 25.0% by weight or at most 22.0% by weight or at most 20.0% by weight, at most 15.0% by weight, at most 10.0% by weight or at most 5.0% by weight. Optionally, the mass ratio of BaO to TiO₂ can be from 0.05 to 0.90, in particularly from 0.05 to 0.80 or from 0.01 to 0.50.

SiO₂ is a glass former. The oxide strongly increases the chemical resistance, but also increases the processing temperatures. When it is used in very high amounts, then the refractive indices provided according to the present invention cannot be achieved. Optionally, the glass contains at least 6.0% by weight, at least 8.0% by weight, or at least 10.0% by weight or at least 11.0% by weight or at least 14.0% by weight or at least 16.5% by weight of SiO₂. Its content can be limited to at most 35.0% by weight, at most 32.0% by weight or at most 30.0% by weight or at most 29.0% by weight or at most 28.5% by weight.

The ratio of contents of boron cations B³⁺ and of silicon cations Si⁴⁺, B³⁺/Si⁴⁺, in % by mol may be at most 2.5, such as at most 1.5 or at most 0.9. Due to its corrosiveness with respect to ceramic melting trough materials the content of B₂O₃ may be limited, such as to at most 12.0% by weight, at most 9.5% by weight, or at most 8.0% by weight or at most 7.0% by weight. In some embodiments, the glass may also be free of boron or it may be limited to at most 1.0% by weight.

ZrO₂ makes a contribution to achieve the high refractive index, but it also increases the tendency of the glass to crystallization so that its content is optionally limited. In some embodiments, its content is up to 5.0% by weight, up to 3.0% by weight or up to 2.0% by weight or up to 1.0% by weight. Some embodiments are free of ZrO₂ or they only contain 0.1% by weight or less.

Al₂O₃ is an optional component of the glass which may make a contribution to the chemical resistance. Its content may be from 0.0 to 5.0% by weight or up to 3.0% by weight, or up to 2.0% by weight or up to 1.0% by weight. Some embodiments are free of Al₂O₃ or they only contain 0.5% by weight or less.

Optionally, ZnO, CaO and SrO can be used in the glass. They decrease the melting temperature and stabilize the glass against crystallization without a reduction of the chemical resistance in an extent such as the alkali metal oxides. Here, the content of ZnO may be from 0.0 to 12.0% by weight, up to 9.5% by weight or up to 8.0% by weight or up to 6.0% by weight. Some embodiments are free of ZnO. The content of SrO may be from 0.0 to 8.0% by weight, or up to 5% by weight or up to 3.0% by weight. Some embodiments are free of SrO. The content of CaO may be from 0.0 to 12.0% by weight, up to 10.0% by weight or up to 8.0% by weight or up to 6.0% by weight. Some embodiments contain at least 0.1% by weight or at least 1.0% by weight or at least 1.5% by weight or at least 2.0% by weight or at least 2.5% by weight or at least 3.0% by weight of CaO.

Li₂O, Na₂O and/or K₂O may be used in the glass. Contents which are too high reduce the chemical resistance. The content of K₂O may be limited to at most 25.0% by weight, such as to at most 20.0% by weight or to at most 18.0% by weight or to at most 15.0% by weight. In some embodiments, the content of K₂O in the glass is at least 0.5% by weight or at least 1.0% by weight or at least 2.0% by weight or at least 3.0% by weight. Optionally, the content of Na₂O is at least 2.0% by weight, at least 3.0% by weight or at least 3.5% by weight. The content of Na₂O may be limited to at most 20.0% by weight, at most 15.0% by weight or at most 11.0% by weight or at most 10.5% by weight. Since Li₂O can attack the material of crucibles and troughs, at the most it is used in low amounts, such as in amounts of less than 1.0% by weight, such as less than 0.5% by weight. The combined content of the three mentioned alkali metal oxides may be from 5.0% by weight to 20.0% by weight, such as from 8.0% by weight to 17.0% by weight. The alkali metal oxides make a contribution to a good processability, but they reduce the chemical resistance.

Sb₂O₃, As₂O₃ and SnO₂ may be used as refining agent. They are only used in low amounts. Due to health hazards, in particularly arsenic and antimony are controversial. The glass can be refined without chemical refining agents. Optionally, vacuum refining can be used.

HfO₂ can be used in amounts of 0.0 to 1.0% by weight, up to 0.5% by weight or up to 0.2% by weight for increasing the refractive index. Some embodiments are free of HfO₂.

Y₂O₃ can be used in amounts of 0.0 to 5.0% by weight, up to 3.5% by weight, up to 2.0% by weight, up to 1.0% by weight, up to 0.5% by weight or up to 0.2% by weight. Some embodiments are free of Y₂O₃.

In some embodiments, the glass comprises the following components in % by weight:

| | |
|---|---|
| SiO₂ | 6.0 to 35.0 |
| B₂O₃ | 0.0 to 12.0 |
| Nb₂O₅ | 10.0 to 55.0 |
| TiO₂ | 10.0 to 50.0 |
| ZrO₂ | 0.0 to 5.0 |
| Al₂O₃ | 0.0 to 5.0 |
| ZnO | 0.0 to 12.0 |
| CaO | 0.0 to 12.0 |
| BaO | 1.0 to 35.0 |
| SrO | 0.0 to 8.0 |
| Na₂O | 0.0 to 20.0 |
| K₂O | 0.0 to 25.0 |
| Sb₂O₃ | 0.0 to 2.0 |
| As₂O₃ | 0.0 to 2.0 |

In some embodiments, the glass comprises the following components in % by weight:

| | |
|---|---|
| SiO₂ | 6.0 to 35.0 |
| B₂O₃ | 0.0 to 12.0 |
| Nb₂O₅ | 10.0 to 55.0 |
| TiO₂ | 10.0 to 50.0 |
| ZrO₂ | 0.0 to 5.0 |
| Al₂O₃ | 0.0 to 5.0 |
| ZnO | 0.0 to 12.0 |
| CaO | 0.0 to 12.0 |
| BaO | 1.0 to 35.0 |
| SrO | 0.0 to 8.0 |
| Na₂O | 0.0 to 20.0 |
| K₂O | 0.0 to 25.0 |
| Sb₂O₃ | 0.0 to 2.0 |
| As₂O₃ | 0.0 to 2.0 |

The glass may comprise the following components in % by weight:

| | |
|---|---|
| SiO₂ | 10.0 to 29.0 |
| B₂O₃ | 0.0 to 8.0 |
| Nb₂O₅ | 12.0 to 45.0 |
| TiO₂ | 15.0 to 40.0 |
| ZrO₂ | 0.0 to 2.0 |
| Al₂O₃ | 0.0 to 2.0 |
| ZnO | 0.0 to 8.0 |
| CaO | 0.0 to 6.0 |
| BaO | 2.0 to 22.0 |
| SrO | 0.0 to 5.0 |
| Na₂O | 2.0 to 15.0 |
| K₂O | 0.0 to 18.0 |
| Sb₂O₃ | 0.0 to 0.3 |
| As₂O₃ | 0.0 to 0.3 |

The glass may comprise the following components in % by weight:

| | |
|---|---|
| SiO₂ | 10.0 to 29.0 |
| B₂O₃ | 0.0 to 8.0 |
| Nb₂O₅ | 12.0 to 45.0 |
| TiO₂ | 15.0 to 40.0 |
| ZrO₂ | 0.0 to 2.0 |
| Al₂O₃ | 0.0 to 2.0 |
| ZnO | 0.0 to 8.0 |
| CaO | 0.0 to 10.0 |
| BaO | 2.0 to 22.0 |
| SrO | 0.0 to 5.0 |
| Na₂O | 2.0 to 15.0 |
| K₂O | 0.0 to 18.0 |
| Sb₂O₃ | 0.0 to 0.3 |
| As₂O₃ | 0.0 to 0.3 |

The glass may comprise the following components in % by weight:

| | |
|---|---|
| SiO₂ | 11.0 to 20.0 |
| B₂O₃ | 0.0 to 7.0 |
| Nb₂O₅ | 17.0 to 40.0 |
| TiO₂ | 15.0 to 34.0 |
| ZrO₂ | 0.0 to 2.0 |
| Al₂O₃ | 0.0 to 1.0 |
| ZnO | 0.0 to 6.0 |
| CaO | 1.0 to 4.0 |
| BaO | 6.0 to 21.0 |
| SrO | 0.0 to 1.0 |
| Na₂O | 3.0 to 11.0 |
| K₂O | 1.0 to 10.0 |
| Sb₂O₃ | 0.0 to 0.5 |
| As₂O₃ | 0.0 to 0.5 |

The glass may comprise the following components in % by weight:

| | |
|---|---|
| SiO₂ | 14.0 to 27.25 |
| B₂O₃ | 0.0 to 7.0 |
| Nb₂O₅ | 13.5 to 40.0 |
| TiO₂ | 16.0 to 37.0 |
| ZrO₂ | 0.0 to 2.0 |
| Al₂O₃ | 0.0 to 1.0 |
| ZnO | 0.0 to 6.0 |
| CaO | 0.4 to 5.0 |
| BaO | 2.95 to 20.5 |
| SrO | 0.0 to 1.0 |
| Na₂O | 3.4 to 10.5 |
| K₂O | 0.8 to 10.0 |
| Sb₂O₃ | 0.0 to 0.5 |
| As₂O₃ | 0.0 to 0.5 |

The glass may comprise the following components in % by weight:

| | |
|---|---|
| SiO₂ | 16.5 to 28.5 |
| B₂O₃ | 0.0 to 7.0 |
| Nb₂O₅ | 12.5 to 40.0 |
| Y₂O₃ | 0.0 to 5.0 |
| TiO₂ | 17.0 to 39.0 |
| ZrO₂ | 0.0 to 2.0 |
| Al₂O₃ | 0.0 to 1.0 |
| ZnO | 0.0 to 6.0 |
| CaO | 1.5 to 8.0 |
| BaO | 0.2 to 10.0 |
| SrO | 0.0 to 1.0 |
| Na₂O | 3.0 to 10.5 |
| K₂O | 3.0 to 15.0 |
| Sb₂O₃ | 0.0 to 0.5 |
| As₂O₃ | 0.0 to 0.5 |

In some embodiments, the glass consists of at least 95.0% by weight, such as of at least 98.0% by weight or of at least 99.0% by weight of the components described here, such as of the components listed in the table above. In some embodiments, the glass substantially completely consists of these components.

In some embodiments, the glass is substantially free of one or more constituents selected from La₂O₃, Gd₂O₃, Y₂O₃, GeO₂, Ta₂O₅, MgO, Li₂O, ZrO₂, WO₃ and combinations thereof.

Due to the contents of niobium, the glass may be free of further expensive components, such as, e.g., tantalum, tungsten and/or germanium. Although in some types of glass they improve diverse optical properties, they are not used here, also due to the fact that it has been found that these components increase, thus worsen, the ratio density/refractive power. The latter is true for, e.g., lanthanum, gadolinium, but also lithium, so in some embodiments these components are not used. Lanthanum and gadolinium, as well as also yttrium, in addition, increase the meltdown temperatures of the mixture and thus the oxygen loss of the melt. In addition, when these components are used, at crystal seeds and interfaces the tendency to crystallization is increased. Li₂O is known for its corrosiveness with respect to ceramic trough and crucible materials, and therefore, when possible, it is not used or it is used only in low amounts.

The melts of the glass can be refined with the classical refining agents, but since the most interesting glasses can often be melted at temperatures of below 1300° C. and due to their low viscosity also a refining process at rather moderate temperatures is possible, the content of, e.g., Sb₂O₃, As₂O₃ and/or SnO₂ can be reduced (e.g., to <0.1% by weight) for the benefit of the UV transmission, or they can be omitted (pure physical refining). Optionally, the glass may comprise one or more of the following components with refining effect in the given portions in % by weight:

| | |
|---|---|
| Sb₂O₃ | 0.0 to 0.5 |
| As₂O₃ | 0.0 to 0.5 |
| SnO₂ | 0.0 to 0.5 |

Optionally, the glass is free of phosphate (P₂O₅), because it results in a melt with considerable reducing properties and thus increases the oxygen requirement of the melt which in turn increases the platinum consumption.

Optionally, the glass is substantially free of one or more constituents selected from lead, bismuth, cadmium, nickel, arsenic, antimony and combinations thereof.

When in this description is mentioned that the glass is free of a component or that it does not contain a certain component, then this means that for this component at the most it is allowed to be present as an impurity in the glass. This means that it is not added in substantial amounts. According to the present invention, not substantial amounts are amounts of less than 100 ppm, such as less than 50 ppm or less than 10 ppm (m/m).

In some exemplary embodiments provided according to the invention, a glass article comprises or consists of the described glass. The glass article may have different forms. Optionally, the article has the form of
a glass for eyeglasses,
a wafer, such as a stack of wafers with a maximum diameter of 5.0 cm to 40.0 cm,
a lens, such as a spherical lens, a prism or an asphere, and/or
a light wave guide, such as a fiber or plate.

In some exemplary embodiments provided according to the invention, a use of a glass or glass article described here in AR eyeglasses, wafer level optics, optical wafer applications, or the classical optics is provided. In an alternative or in addition, the glass described here or the glass article described here can be used as wafer, lens, spherical lens or light wave guide.

### EXAMPLES

The example compositions shown in the following Tables 1 to 6 were melted and their properties were investigated. For some of the glasses the internal transmission was determined.

### Compositions and Properties

TABLE 1

| % by | | | | | | | | |
|---|---|---|---|---|---|---|---|---|
| weight | 1 | 2 | 3 | 4 | 5 | 6 | 7 | 8 |
| SiO₂ | 16.00 | 14.00 | 14.00 | 16.00 | 18.00 | 23.31 | 15.00 | 17.00 |
| B₂O₃ | 2.00 | 3.00 | | 1.00 | | 2.88 | 4.00 | |
| Nb₂O₅ | 25.00 | 28.00 | 22.00 | 26.00 | 23.00 | 13.75 | 33.00 | 30.00 |
| TiO₂ | 29.00 | 29.00 | 34.00 | 30.00 | 32.00 | 36.88 | 23.00 | 27.00 |
| ZrO₂ | | 2.00 | | | | | | |
| Al₂O₃ | | 1.00 | | | | | | |
| ZnO | 5.00 | 0.00 | 6.00 | 5.00 | 5.00 | 2.36 | 2.00 | 3.00 |
| CaO | 3.00 | 1.50 | 3.00 | 3.00 | 3.00 | 2.13 | 4.00 | 4.00 |
| BaO | 12.00 | 11.00 | 12.00 | 11.00 | 12.00 | 7.82 | 8.00 | 9.00 |
| SrO | | | 1.00 | | | | | |
| Na₂O | 7.00 | 8.00 | 7.00 | 7.00 | 7.00 | 9.20 | 9.50 | 8.50 |
| K₂O | 1.00 | 2.50 | 1.00 | 1.00 | 1.00 | 1.67 | 2.00 | 2.00 |
| As₂O₃ | 0.05 | 0.05 | 0.05 | 0.05 | 0.05 | 0.05 | 0.05 | 0.05 |

properties

| | | | | | | | | |
|---|---|---|---|---|---|---|---|---|
| nd | 1.9536 | 1.9408 | 1.9877 | 1.9674 | 1.9586 | 1.8895 | 1.9151 | 1.9396 |
| vd | 20.8 | 20.5 | 20.1 | 20.3 | 20.5 | | 21.7 | 21.1 |
| Tg | 605 | | 603 | 597 | 614 | 586 | 557 | 588 |
| density | 3.7659 | 3.6527 | 3.8473 | 3.7744 | 3.7537 | 3.3911 | 3.6204 | 3.6916 |
| density/nd | 1.9277 | 1.8821 | 1.9356 | 1.9185 | 1.9165 | 1.7947 | 1.8904 | 1.90 |

TABLE 2

| % by | | | | | | | | |
|---|---|---|---|---|---|---|---|---|
| weight | 9 | 10 | 11 | 12 | 13 | 14 | 15 | 16 |
| SiO₂ | 18.00 | 18.00 | 20.00 | 25.75 | 19.73 | 20.00 | 20.18 | 20.00 |
| B₂O₃ | 1.50 | | | 4.07 | 6.04 | | | |
| Nb₂O₅ | 34.00 | 29.00 | 30.00 | 33.25 | 26.94 | 30.00 | 29.47 | 26.00 |
| TiO₂ | 22.00 | 25.00 | 26.00 | 17.11 | 23.68 | 26.00 | 25.88 | 24.00 |
| ZnO | 3.00 | | | 3.56 | 3.12 | | | |
| CaO | 3.00 | 4.00 | 4.00 | 1.80 | 3.01 | 4.00 | 4.08 | 4.00 |
| BaO | 14.00 | 14.00 | 10.00 | 5.28 | 5.40 | 10.00 | 9.75 | 16.00 |
| SrO | | | | | | | 0.01 | |
| Na₂O | 8.50 | 7.00 | 8.50 | 3.40 | 5.55 | 8.50 | 8.54 | 8.50 |
| K₂O | 2.00 | 3.50 | 2.00 | 5.78 | 6.53 | 2.00 | 2.03 | 2.00 |
| Sb₂O₃ | | | | | | | 0.01 | |
| As₂O₃ | 0.05 | 0.05 | 0.05 | 0.05 | 0.05 | 0.05 | 0.06 | 0.05 |

properties

| | | | | | | | | |
|---|---|---|---|---|---|---|---|---|
| nd | 1.9132 | 1.9147 | 1.9171 | 1.8691 | 1.8776 | | 1.9173 | |
| vd | 22.3 | 22.1 | 21.6 | 23.2 | 22.6 | | 21.6 | |
| Tg | 584 | 612 | 617 | 573 | 553 | 616 | 616 | 614 |
| density | 3.7529 | 3.6942 | 3.6219 | 3.3764 | 3.394 | | 3.6147 | |
| density/nd | 1.9616 | 1.9294 | 1.8893 | 1.8432 | 1.8276 | | 1.8853 | |

TABLE 3

| % by | | | | | | | | |
|---|---|---|---|---|---|---|---|---|
| weight | 17 | 18 | 19 | 20 | 21 | 22 | 23 | 24 |
| SiO₂ | 20.10 | 21.67 | 20.46 | 20.48 | 19.89 | 19.69 | 21.70 | 20.00 |
| Nb₂O₅ | 25.50 | 28.96 | 28.14 | 30.07 | 29.18 | 28.89 | 25.00 | 24.00 |
| TiO₂ | 23.90 | 25.36 | 26.44 | 24.48 | 25.69 | 25.49 | 23.50 | 24.00 |
| CaO | 4.09 | 3.99 | 4.14 | 4.17 | 4.00 | 4.00 | 4.02 | 4.00 |
| BaO | 15.71 | 9.59 | 9.96 | 10.03 | 10.73 | 9.59 | 15.39 | 16.00 |
| SrO | 0.10 | 0.01 | 0.01 | 0.01 | 0.01 | 0.01 | 0.01 | |
| Na₂o | 8.50 | 8.39 | 8.73 | 8.64 | 8.43 | 8.32 | 8.331 | 8.50 |
| K₂O | 2.02 | 1.99 | 2.07 | 2.07 | 2.01 | 3.96 | 1.98 | 2.00 |
| As₂O₃ | 0.06 | 0.06 | 0.06 | 0.06 | 0.06 | 0.05 | 0.06 | 0.05 |

properties

| | | | | | | | | |
|---|---|---|---|---|---|---|---|---|
| nd | 1.8885 | 1.9059 | 1.9108 | 1.9073 | 1.9163 | 1.8997 | 1.8792 | 1.8818 |
| vd | 23.2 | 21.8 | 21.8 | 22.0 | 21.7 | 22.2 | 23.5 | 23.5 |
| Tg | 614 | 620 | 611 | 614 | 617 | 604 | 623 | 610 |
| density | 3.6793 | 3.5819 | 3.5973 | 3.6128 | 3.633 | 3.578 | 3.6503 | 3.6608 |
| density/nd | 1.9482 | 1.8794 | 1.8826 | 1.8942 | 1.8959 | 1.8835 | 1.9424 | 1.9454 |

TABLE 4

| % by | | | | | | | | |
|---|---|---|---|---|---|---|---|---|
| weight | 25 | 26 | 27 | 28 | 29 | 30 | 31 | 32 |
| SiO₂ | 20.49 | 20.29 | 19.90 | 14.00 | 17.08 | 20.00 | 16.00 | 18.00 |
| B₂O₃ | | | | 6.00 | | | 6.00 | |
| Nb₂O₅ | 25.99 | 25.78 | 25.19 | 35.00 | 18.58 | 26.00 | 33.00 | 40.00 |
| TiO₂ | 22.39 | 24.18 | 23.69 | 21.00 | 28.97 | 24.00 | 19.00 | 16.00 |
| ZnO | | | | 2.00 | | | 3.00 | |
| CaO | 4.18 | 4.15 | 4.06 | 2.00 | 3.06 | 4.00 | 3.00 | 4.00 |
| BaO | 16.06 | 14.83 | 15.60 | 9.00 | 20.18 | 16.00 | 7.00 | 7.00 |
| SrO | 0.11 | 0.10 | 0.11 | 1.00 | 0.14 | | | |
| Na₂O | 8.67 | 8.58 | 8.41 | 9.00 | 9.44 | 8.50 | 10.50 | 7.00 |
| K₂O | 2.06 | 2.03 | 2.99 | 5.00 | 2.50 | 2.00 | 3.00 | 10.00 |
| As₂O₃ | 0.06 | 0.06 | 0.06 | 0.05 | 0.05 | 0.05 | 0.05 | 0.05 |

properties

| | | | | | | | | |
|---|---|---|---|---|---|---|---|---|
| nd | 1.8780 | 1.8895 | 1.8796 | 1.8880 | 1.8876 | 1.8881 | 1.8671 | 1.8533 |
| vd | 23.8 | 23.1 | 23.6 | 22.4 | 23.4 | 23.3 | 23.2 | 24.2 |
| Tg | 612 | 616 | 601 | 538 | 577 | 610 | 534 | 578 |
| density | 3.6772 | 3.6647 | 3.6575 | 3.5954 | 3.7063 | 3.6811 | 3.5292 | 3.5443 |
| Knoop | | | | | | 576 | | |
| hardness | | | | | | | | |
| E modulus | | | | | | 100 | | |
| density/nd | 1.9580 | 1.9395 | 1.9459 | 1.9043 | 1.9635 | 1.9497 | 1.89 | 1.9125 |

TABLE 5

| % by | | | | | | | | |
|---|---|---|---|---|---|---|---|---|
| weight | 33 | 34 | 35 | 36 | 37 | 38 | 39 | 40 |
| SiO₂ | 15.00 | 19.89 | 18.00 | 24.00 | 26.19 | 24.13 | 24.50 | 24.50 |
| B₂O₃ | 7.00 | 0.83 | 3.00 | 2.00 | | | | |
| Nb₂O₅ | 33.00 | 17.49 | 28.00 | 16.00 | 13.75 | 22.60 | 23.00 | 21.90 |
| Y₂O₃ | | | | | | | | 3.00 |
| TiO₂ | 18.00 | 25.69 | 20.00 | 35.00 | 36.88 | 28.78 | 31.00 | 31.00 |
| ZnO | 2.00 | | | 2.50 | 2.36 | 3.23 | | |
| CaO | 2.00 | 2.03 | 4.00 | 2.00 | 2.13 | 3.10 | 5.00 | 5.00 |
| BaO | 9.00 | 19.50 | 16.00 | 7.00 | 7.82 | 5.68 | 2.00 | 2.20 |
| SrO | 1.00 | 0.14 | | | | | | |
| Na₂O | 9.00 | 10.33 | 4.00 | 8.00 | 9.20 | 5.73 | 7.00 | 6.50 |
| K₂O | 5.00 | 4.05 | 10.00 | 3.50 | 1.67 | 6.75 | 6.00 | 6.50 |
| As₂O₃ | 0.05 | 0.05 | 0.05 | 0.05 | 0.05 | 0.05 | 0.05 | 0.05 |

properties

| | | | | | | | | |
|---|---|---|---|---|---|---|---|---|
| nd | 1.8562 | 1.8359 | 1.8420 | 1.8843 | 1.8851 | 1.8702 | 1.8780 | 1.8773 |
| vd | 23.7 | 25.2 | | 21.4 | 21.4 | 22.3 | 21.6 | 22.2 |
| Tg | 534 | 545 | 565 | 586 | 610 | 601 | 608 | 622 |
| density | 3.5374 | 3.5793 | 3.5669 | 3.3818 | 3.393 | 3.4161 | 3.314 | 3.3573 |
| density/nd | 1.9057 | 1.9496 | 1.9365 | 1.7947 | 1.7999 | 1.8266 | 1.7646 | 1.7884 |

TABLE 6

| % by | | | |
|---|---|---|---|
| weight | 41 | 42 | 43 |
| SiO₂ | 22.50 | 23.50 | 23.00 |
| B₂O₃ | 1.50 | | |
| Nb₂O₅ | 21.90 | 21.90 | 22.00 |
| Y₂O₃ | 3.00 | 3.00 | 4.00 |
| TiO₂ | 31.00 | 31.50 | 31.00 |
| CaO | 5.00 | 4.50 | 4.50 |
| BaO | 2.20 | 1.00 | 0.50 |
| Na₂O | 6.50 | 6.50 | 6.50 |
| K₂O | 6.50 | 9.00 | 9.00 |
| As₂O₃ | 0.05 | 0.05 | 0.05 |
| nd | 1.8816 | 1.8459 | 1.8692 |
| vd | 22.1 | 22.0 | 22.4 |
| Tg | 610 | 611 | 615 |
| Dichte | 3.3645 | 3.3159 | 3.3278 |
| Dichte/nd | 1.7881 | 1.7964 | 1.7803 |

The glasses of the examples show excellent ratios of density to refractive index. They have a low density and at the same time a high refractive index, low dispersion and relatively low Tg.

Internal Transmission

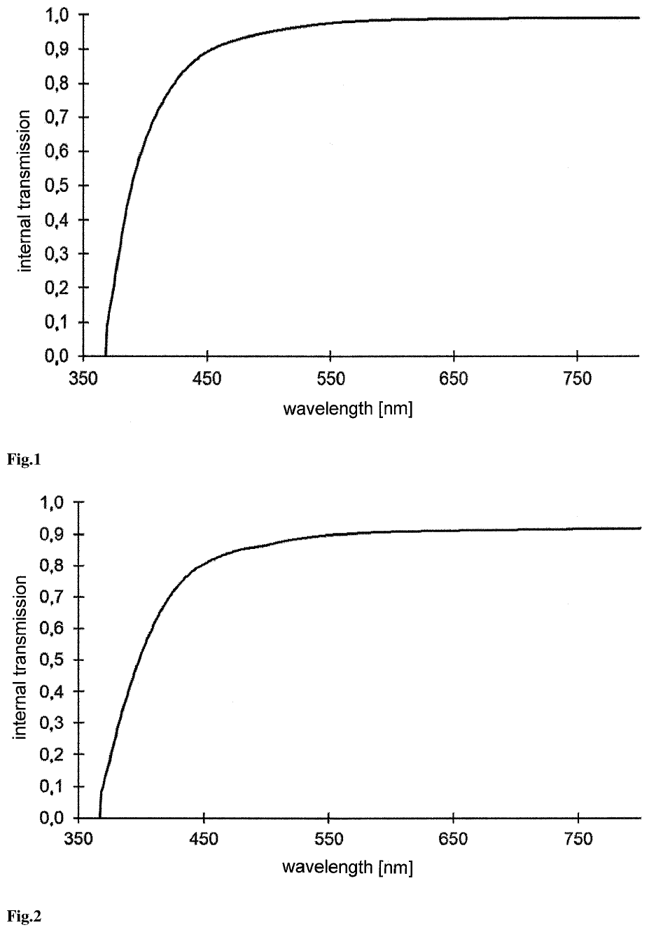

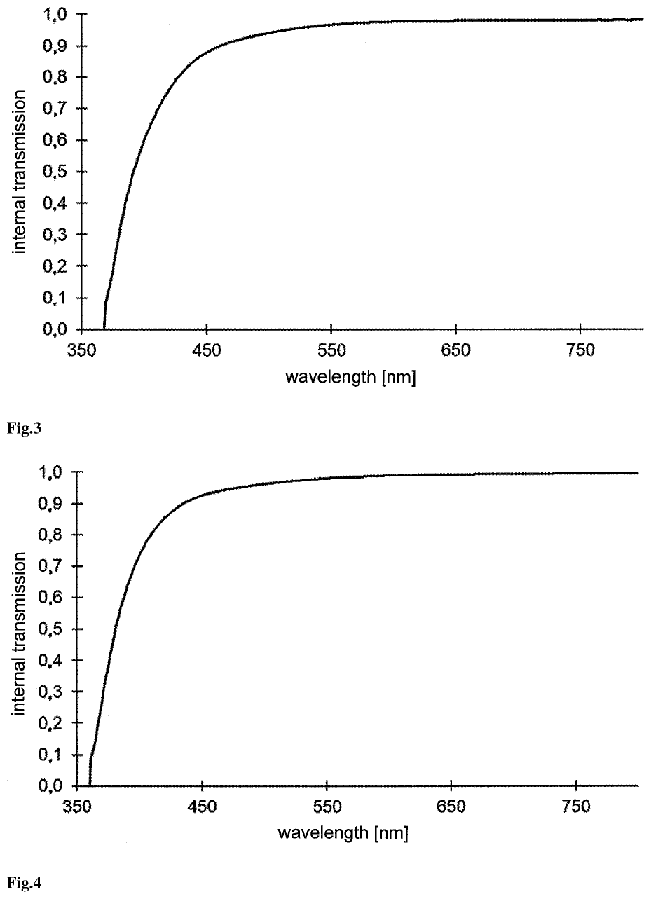

FIGS. 1 to 4 show internal transmission spectra of the example glasses 17 (FIG. 1), 29 (FIG. 2), 30 (FIG. 3) and 34 (FIG. 4).

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A glass with a low ratio of density ρ and refractive index n_{d}, the glass having a refractive index n_{d} in a range of 1.80 to 2.00, an internal transmission of at least 80% (450 nm, 10 mm), a dispersion v_{d} of 19.0 to 27.0, and a ratio ρ/n_{d} of <1.97.

2. The glass of claim 1, wherein at least one of the following is satisfied:
the glass has a refractive index n_{d} of 1.85 to 1.95; or
the glass has a ratio ρ/n_{d} of <1.95.

3. The glass of claim 1, wherein the glass has a content of at least one of Ta₂O₅, WO₃ or GeO₂ of less than 5.0% by weight.

4. The glass of claim 1, wherein the glass has a combined content of Nb₂O₅, TiO₂ and BaO of at least 30% by weight.

5. The glass of claim 4, wherein the combined content of Nb₂O₅, TiO₂ and BaO is at least 45% by weight.

6. The glass of claim 1, wherein the glass has at least one of:
a Knoop hardness of 500 to 650;
a glass transition temperature Tg of 500° C. to 650° C.; or
a chemical resistance corresponding to class 0, 1 or 2 according to DIN 12116:2001.

7. The glass of claim 1, wherein the glass contains boron cations B³⁺ and silicon cations SO⁺ and a ratio of the contents of boron cations B³⁺ and of silicon cations Si⁴⁺, B³⁺/Si⁴⁺, in % by mol in the glass is at most 2.5.

8. The glass of claim 1, wherein the glass comprises the following components in % by weight:

| | |
|---|---|
| SiO₂ | 6.0 to 35.0 |
| B₂O₃ | 0.0 to 12.0 |
| Nb₂O₅ | 10.0 to 55.0 |
| TiO₂ | 10.0 to 50.0 |
| ZrO₂ | 0.0 to 5.0 |
| Al₂O₃ | 0.0 to 5.0 |
| ZnO | 0.0 to 12.0 |
| CaO | 0.0 to 12.0 |
| BaO | 1.0 to 35.0 |
| SrO | 0.0 to 8.0 |
| Na₂O | 0.0 to 20.0 |
| K₂O | 0.0 to 25.0 |
| Sb₂O₃ | 0.0 to 2.0 |
| As₂O₃ | 0.0 to 2.0 |

9. The glass of claim 8, wherein the glass comprises the following components in % by weight:

| | |
|---|---|
| SiO₂ | 6.0 to 35.0 |
| B₂O₃ | 0.0 to 12.0 |
| Nb₂O₅ | 10.0 to 55.0 |
| TiO₂ | 10.0 to 50.0 |
| ZrO₂ | 0.0 to 5.0 |
| Al₂O₃ | 0.0 to 5.0 |
| ZnO | 0.0 to 12.0 |
| CaO | 0.0 to 12.0 |
| BaO | 1.0 to 35.0 |
| SrO | 0.0 to 8.0 |
| Na₂O | 0.0 to 20.0 |
| K₂O | 0.0 to 25.0 |
| Sb₂O₃ | 0.0 to 2.0 |
| As₂O₃ | 0.0 to 2.0 |

10. The glass of claim 9, wherein the glass comprises the following components in % by weight:

| | |
|---|---|
| SiO₂ | 10.0 to 29.0 |
| B₂O₃ | 0.0 to 8.0 |
| Nb₂O₅ | 12.0 to 45.0 |
| TiO₂ | 15.0 to 40.0 |
| ZrO₂ | 0.0 to 2.0 |
| Al₂O₃ | 0.0 to 2.0 |
| ZnO | 0.0 to 8.0 |
| CaO | 0.0 to 6.0 |
| BaO | 2.0 to 22.0 |
| SrO | 0.0 to 5.0 |
| Na₂O | 2.0 to 15.0 |
| K₂O | 0.0 to 18.0 |
| Sb₂O₃ | 0.0 to 0.3 |
| As₂O₃ | 0.0 to 0.3 |

11. The glass of claim 1, wherein the glass is substantially free of one or more constituents selected from La₂O₃, Gd₂O₃, Y₂O₃, GeO₂, Ta₂O₅, MgO, Li₂O, ZrO₂, P₂O₅, WO₃ and combinations thereof.

12. The glass of claim 1, wherein the glass is substantially free of one or more constituents selected from lead, bismuth, cadmium, nickel, arsenic, antimony and combinations thereof.

13. A glass article, comprising:
a glass with a low ratio of density ρ and refractive index n_{d}, the glass having a refractive index n_{d} in a range of 1.80 to 2.00, an internal transmission of at least 80% (450 nm, 10 mm), a dispersion v_{d} of 19.0 to 27.0, and a ratio ρ/n_{d} of <1.97, wherein the glass article is in the form of:
a glass for eyeglasses;
a stack of wafers,
a wafer;
a lens;
a spherical lens;
a prism;
an asphere;
a light wave guide;
a fiber; or
a plate.

14. The glass article of claim 13, wherein the glass article is in the form of a wafer with a maximum diameter of 5.0 cm to 40.0 cm.

15. The glass article of claim 13, wherein at least one of the following is satisfied:
the glass has a refractive index n_{d} of 1.85 to 1.95; or
the glass has a ratio ρ/n_{d} of <1.95.

16. The glass article of claim 13, wherein the glass has a content of at least one of Ta₂O₅, WO₃ or GeO₂ of less than 5.0% by weight.

17. The glass article of claim 13, wherein the glass has a combined content of Nb₂O₅, TiO₂ and BaO of at least 30% by weight.

18. The glass article of claim 17, wherein the combined content of Nb₂O₅, TiO₂ and BaO is at least 45% by weight.

19. The glass article of claim 13, wherein the glass has at least one of:
a Knoop hardness of 500 to 650;
a glass transition temperature Tg of 500° C. to 650° C.; or
a chemical resistance corresponding to class 0, 1 or 2 according to DIN 12116:2001.

20. The glass article of claim 13, wherein the glass comprises the following components in % by weight:

| | |
|---|---|
| SiO₂ | 6.0 to 35.0 |
| B₂O₃ | 0.0 to 12.0 |
| Nb₂O₅ | 10.0 to 55.0 |
| TiO₂ | 10.0 to 50.0 |
| ZrO₂ | 0.0 to 5.0 |
| Al₂O₃ | 0.0 to 5.0 |
| ZnO | 0.0 to 12.0 |
| CaO | 0.0 to 12.0 |
| BaO | 0.1 to 35.0 |
| SrO | 0.0 to 8.0 |
| Na₂O | 0.0 to 20.0 |
| K₂O | 0.0 to 25.0 |
| Sb₂O₃ | 0.0 to 2.0 |
| As₂O₃ | 0.0 to 2.0 |
